(19) United States
(12) Patent Application Publication
(10) Pub. No.: US 2007/0124640 A1
(43) Pub. Date: May 31, 2007

(54) Automatic request apparatus and method for multihop system broadband wireless access communication network

(75) Inventors: Kyung-Joo Suh, Seoul (KR); Soon-Young Yoon, Seoul (KR); Jae-Hee Cho, Seoul (KR); Geun-Ho Lee, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/593,389

(22) Filed: Nov. 6, 2006

(30) Foreign Application Priority Data
Nov. 4, 2005 (KR) 2005-0105529

(51) Int. Cl. H04L 1/18; G08C 25/02

(52) U.S. Cl. 714/748

(57) ABSTRACT

Provided are an Automatic ReQuest (ARQ) apparatus and method for a multihop system in a broadband wireless access communication system. When the number of ACK MAPs in ARQ feedback information element of ARQ feedback message transmitted from a destination or Multi-Hop Base Transceiver Station (MH-BTS) is not zero, and it is determined that the destination or a lower MH-BTS successfully receives data corresponding to Block Sequence Number (BSN), the BSN is updated with a BSN successfully received at the destination or the lower MH-BTS, and is transmitted to the upper MH-BTS or the source. Accordingly, when the MH-BTS successfully receives the data from the source but the destination fails to receive the data, the source does not retransmit same data to the MH-BTS.

### PRIORITY

This application claims priority under 35 U.S.C. § 119 to an application filed in the Korean Intellectual Property Office on Nov. 4, 2005 and assigned Serial No. 2005-105529, the contents of which are incorporated herein by reference.

### BACKGROUND OF THE INVENTION

1. Field of the Invention

The present invention relates generally to an automatic request apparatus and method for a multihop system in a broadband wireless access communication network.

2. Description of the Related Art

With the increase of services requiring a higher data rate, there is a demand for a communication system to provide a higher data rate than a Third Generation (3G) mobile communication using Code Division Multiple Access (CDMA).

A multihop technology using a relay is essential for implementation of a system having a higher data rate and a wider area of service coverage. According to the multihop technology, a relay is located between a Base Transceiver Station (BTS) and a Mobile Station (MS), which relay is referred to as an MH-BTS (multihop-BTS).

When data is transmitted from the BTS to the MS, an Automatic Request (ARQ) technology is used for reliable data transmission.

According to the multihop technology, instead of directly transmitting data from the BTS to the MS, the MH-BTS located between the BTS and the MS receives data from the BTS and transmits the received data to the MS. Because of the addition of the MH-BTS, the multihop technology requires a new ARQ scheme, thus necessitating a new ARQ mechanism and message scheme.

When the conventional ARQ technology is used in the multihop system, an ARQ state between the BTS and the MH-BTS and an ARQ state between the MH-BTS and the MS must be considered.

When the MS is a destination in data transmission, whether the MS successfully receives an ARQ block or not can be known from an ARQ feedback message transmitted from the MS to the BTS.

The ARQ block indicates whether data error occurs. The ARQ feedback message is used in the Institute of Electrical and Electronics Engineers (IEEE) 802.16 system and is transmitted together with a generic Medium Access Control (MAC) header.

Table 1 below shows an ARQ feedback message format.

TABLE 1

| Syntax | Size |
|---|---|
| ARQ_Feedback_Message Format( ){ | |
| Management Message Type = 33 | 8 bits |
| ARQ_Feedback_Payload | variable |
| } | |

In Table 1, “Management Message Type=33” represents that the message is the ARQ feedback message. The ARQ feedback payload format is defined as Table 2 below.

TABLE 2

| Syntax | Size | Notes |
|---|---|---|
| ARQ_Feedback_Payload_Format( ){ | | |
| do | | |
| ARQ_Feedback_IE(LAST) | variable | Insert as many as |
| | | desired, until |
| | | LAST= =TRUE |
| until (last) | | |
| } | | |

The ARQ feedback payload format includes a plurality of ARQ feedback Information Element (IE) formats. The ARQ feedback IE format is defined as Table 3 below.

TABLE 3

| Syntax | Size | Notes |
|---|---|---|
| ARQ_feedback_IE(LAST){ | variable | |
| CID | 16 bits | The ID of the connection |
| | | being referenced |
| LAST | 1 bit | 0=More ARQ Feedback IE |
| | | in list |
| | | 1=Last ARQ Feedback IE |
| | | in list |
| ACK Type | 2 bits | 0×0=Selective ARQ entry |
| | | 0×1=Cumulative ACK |
| | | entry |
| | | 0×2=Cumulative with |
| | | Selective entry |
| | | 0×3=Cumulative ACK with |
| | | block |
| | | Sequence ACK entry |
| BSN | 11 bits | |
| Number of ACK MAPs | 2 bits | If ACK Type= =01, |
| | | the field is reserved and set |
| | | to 00. Otherwise |
| | | the field indicates the |
| | | number of ACK MAPs; |
| | | 0×0=1, |
| | | 0×1=2, |
| | | 0×2=3, 0×3=4 |
| If(ACK Type!=01) { | | |
| For(i=0;i<Number of ACK | | |
| MAPs+1;++1) { | | |
| If(ACK Type!=3) { | | |
| Selective ACK MAP | 16 bits | |
| } | | |
| Else { | | Start of Block Sequence |
| | | ACK MAP definition |
| | | (16 bits) |
| Sequence Format | 1 bit | Number of Block sequences |
| | | associated with descriptor |
| | | 0: 2 Block sequence |
| | | 1: 3 Block sequence |
| If(Sequence Format=0) { | | |
| Sequence ACK MAP | 2 bits | |
| Sequence 1 length | 6 bits | |
| Sequence 2 length | 6 bits | |
| Reserved | 1 bit | |
| } | | |
| Else { | | |
| Sequence ACK MAP | 3 bits | |
| Sequence 1 Length | 4 bits | |
| Sequence 2 Length | 4 bits | |
| Sequence 3 length | 4 bits | |
| } | | |
| } | | End of Block Sequence |
| | | ACK MAP definition |
| } | | |
| } | | |
| } | | |

In the case of the cumulative ACK ARQ format, whether the MS successfully receives the ARQ block is represented in the Block Sequence Number (BSN) field of Table 3.

If the MH-BTS does not transparently relay the ARQ feedback information between the BS and the MS, the management of the data received from the BTS and the ARQ received from the MS becomes complicated and the data to be transmitted to the MS is continuously accumulated in a buffer of the MH-BTS, resulting in ineffective data transmission/reception.

FIG. 1 illustrates a conventional transmission environment of an ARQ feedback IE.

Referring to FIG. 1, a Service Data Unit (SDU) #1 105 and an SDU #2 110 are fragmented into three Protocol Data Units (PDUs) 115, 120 and 125.

The SDUs 105 and 110 and the PDUs 115, 120 and 125 are all used in a datalink layer, and the SDUs 105 and 110 are located at a higher layer than the PDU 115, 120 and 125. “#” indicates a sequence number.

In FIG. 1, the destination successfully receives the PDU#1 115 and the PDU#3 125, but fails to receive the PDU#2 120.

Table 4 below shows the ARQ feedback IE when the cumulative ACK entry is used in the environment of FIG. 1.

TABLE 4

| Name | Size | Description |
|---|---|---|
| CID | ###### | Connection ID of destination |
| LAST | 1 | Indicates the last ARQ feedback IE |
| ACK | 0×1 | Indicates the use of cumulative ACK entry |
| Type | | |
| BSN | 7 | Indicates that all blocks having |
| | | a smaller value |
| | | than a corresponding block are successfully |
| | | received |
| Number of | 0×0 | 00 = Reserved |
| ACK | | |
| MAPs | | |

Upon the forward data transmission, if the MH-BTS does not manage the ARQ state between the BTS and the MS, that is, the MH-BTS only transmits the ARQ feedback information, the BTS retransmits the same data to the MH-BTS when the MS does not successfully receive the data, even though the MH-BTS successfully receives the data from the BTS.

Upon the reverse data transmission, the MS retransmits the same data to the MH-BTS when the BTS does not successfully receive the data, even though the MH-BTS successfully receives the data from the MS. This results in ineffective data transmission/reception.

### SUMMARY OF THE INVENTION

An object of the present invention is to substantially solve at least the above problems and/or disadvantages and to provide at least the advantages below. Accordingly, an object of the present invention is to provide an ARQ apparatus and method for a multihop system in a broadband wireless access communication network.

According to the present invention, an ARQ apparatus of a relay in a broadband wireless access communication network includes a receive data sorter for sorting received data according to transmission nodes a receive data analyzer for analyzing the data of a lower node, which is received from the receive data sorter, and determining whether the lower node successfully receives the data, a transmit data processor for generating a first feedback data containing the information about data reception success/fail of an upper node and outputting the first feedback data together with the data of the upper node, a receive data processor for receiving the analysis result of the receive data analyzer and the first feedback data to generate a second feedback data to be transmitted to the upper node, the second feedback data containing reception success/fail of the lower node containing the relay, and a transmit data adjuster for receiving the first feedback data from the transmit data processor to output the received first feedback data to the receive data processor, scheduling the data of the upper node and the second feedback data, and transmitting the data and the second feedback data through an antenna.

According to the present invention, an ARQ method of a relay in a broadband wireless access communication network includes determining whether data from an upper node is successfully received, receiving a first feedback data from a lower node when or after the determining step is carried out, generating a second feedback data when it is determined from the first feedback data that the lower node fails to receive the data and the relay successfully receives the data, and transmitting the first feedback data and the second feedback data to the upper node, the second feedback data containing the determination result indicating whether the data from the upper node is successfully received.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional transmission environment of an ARQ feedback IE;

FIG. 2 illustrates a broadband wireless access communication network supporting a multihop system according to the present invention;

FIG. 3 is a block diagram of an ARQ apparatus of a source according to the present invention;

FIG. 4 is a block diagram of an ARQ apparatus of an MH-BTS according to the present invention;

FIG. 5 is a flowchart illustrating an operation of an MH-BTS for generating a cumulative ACK MAP in a multihop system according to the present invention;

FIG. 6 illustrates a TLV format according to the present invention;

FIGS. 7A and 7B are flowcharts illustrating an analysis process of a source receiving a cumulative ACK MAP in a multihop system according to the present invention;

FIG. 8 illustrates an operation environment and a PDU TX/RX success/fail in a 2-hop system according to the present invention; and

FIG. 9 illustrates an operation environment and a PDU TX/RX success/fail in a 3-hop system according to the present invention.

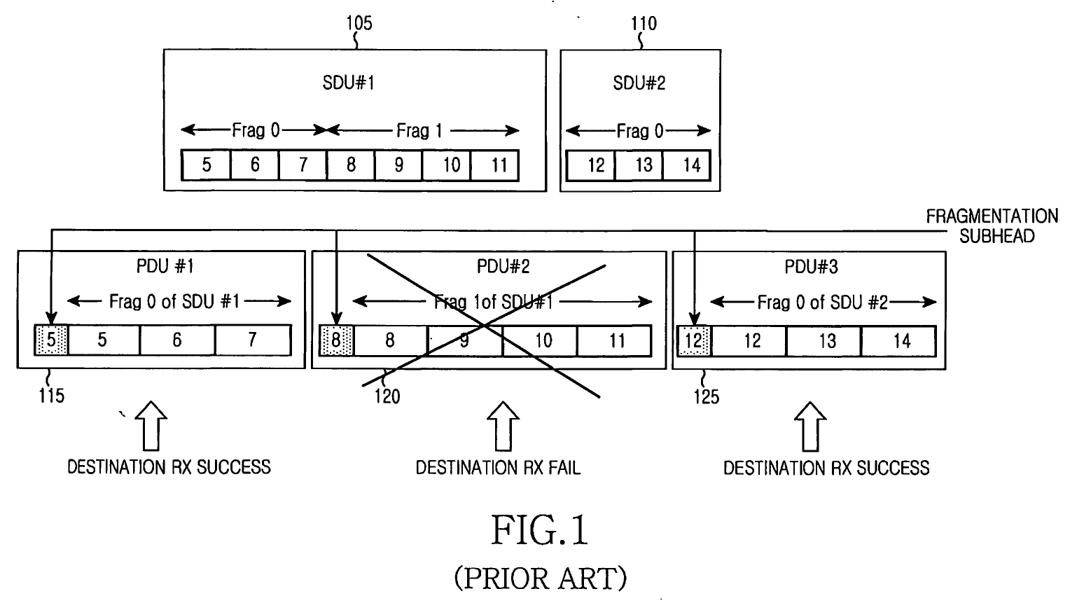

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

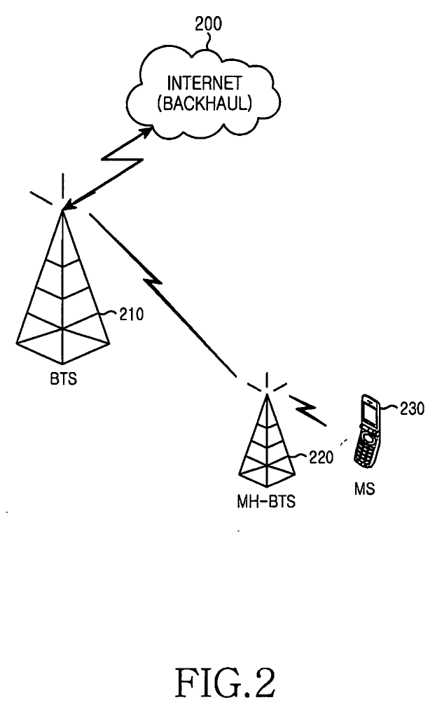

FIG. 2 illustrates a broadband wireless access communication network supporting a multihop system according to the present invention.

Referring to FIG. 2, an MS 230 transmits/receives data to/from a BTS 210 through an MH-BTS 220. The BTS 210 is connected to the Internet (backhaul) 200.

The MS 230 transparently manages an ARQ state between the MS 230 and the BTS 210 without regard to the MH-BTS 220.

In the case of the forward link, the MH-BTS 220 receives data from the BTS 210 and transmits the received data to the MS 230. Also, the MH-BTS 220 combines ACK/NACK for the received data and ARQ feedback information received from the MS 230 and reconfigures a dedicated ARQ feedback IE of the MH-BTS 220.

When the dedicated ARQ feedback IE is used, the BTS 210 does not retransmit the data that is successfully received by the MH-BTS 220.

The destination transmits to the MH-BTS 220 the ARQ feedback message generated using the conventional ARQ feedback IE format.

In the case of the forward link, the MS 230 and the BTS 210 are the destination and the source, respectively. In the case of the reverse link, the MS 230 and the BTS 210 are the source and the destination, respectively.

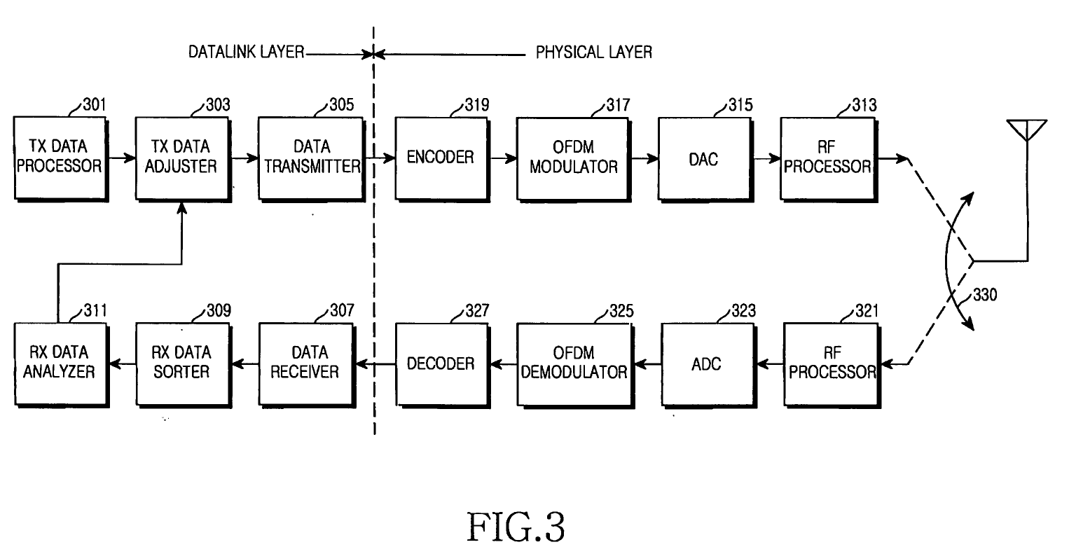

FIG. 3 is a block diagram of an ARQ apparatus of a source according to the present invention.

Referring to FIG. 3, the ARQ apparatus of the source is divided into a physical layer apparatus and a datalink layer apparatus. The physical layer apparatus includes a transmitter, a receiver, and a Radio Frequency (RF) switch 330.

Although the physical layer apparatus using an Orthogonal Frequency Division Multiplexing (OFDM) scheme will be taken as an example, the present invention can also be applied to a Code Division Multiple Access (CDMA) scheme and a Time Division Multiple Access (TDMA) scheme using a Time Division Duplex (TDD).

In addition, although the physical layer apparatus will be described focusing on a TDD system, the present invention can also be applied to a Frequency Division Duplex (FDD) system because the ARQ apparatus is independent of the physical layer apparatus.

The receiver includes an RF processor 321, an Analog-to-Digital Converter (ADC) 323, an OFDM demodulator 325, and a decoder 327.

The RF processor 321 converts an RF signal received through an antenna into a baseband analog signal. The ADC 323 converts the baseband analog signal into a digital signal.

The OFDM demodulator 325 Fast Fourier Transform (FFT)-processes time-domain sample data received from the ADC 323 into frequency-domain data.

The decoder 327 decodes the frequency-domain data at a coding rate in a modulation scheme and outputs the decoded data to a data receiver 307.

The transmitter includes an encoder 319, an OFDM modulator 317, a Digital-to-Analog Converter (DAC) 315, and an RF processor 313.

The encoder 319 encodes data received from a data transmitter 305 in a modulation scheme. Examples of the modulation scheme include Binary Phase Shift Keying (BPSK), Quadrature Phase Shift Keying (QPSK), 16 Quadrature Amplitude Modulation (16QAM), and 64QAM.

The OFDM modulator 317 Inverse FFT (IFFT)-processes the data received from the encoder 319 to output time-domain sample data (OFDM symbol).

The DAC 315 converts the time-domain sample data into an analog signal. The RF processor 313 converts the analog signal into an RF signal and transmits the RF signal through the antenna.

Upon receipt of data, the RF switch 330 connects the receiver to the antenna. Upon transmission of data, the RF switch 330 connects the transmitter to the antenna.

In the datalink layer apparatus, a Transmit (TX) data processor 301 fragments data to be transmitted, inserts header information, and transmits to a TX data adjuster 303.

The TX data adjuster 303 manages a data transmission scheduling and a TX data processing and transmits the data to the data transmitter 305.

The data transmitter 305 transmits the data to the encoder 319.

The data receiver 307 receives data from the decoder 327 and transmits the received data to an RX data sorter 309.

The RX data sorter 309 sorts the received data into data received from the destination and data received from the MH-BTS 220, and transmits the sorted data to an RX data analyzer 311.

The RX data analyzer 311 analyzes the received data according to whether it is received from the MH-BTS 220 or the destination. When the relay successfully receives the data but the destination fails to receive the data, the RX data analyzer 311 decides not to retransmit the corresponding data. When the relay fails to receive the data, the RX data analyzer 311 decides to retransmit the corresponding data and transmits it to the TX data adjuster 303.

The TX data adjuster 303 determines whether to retransmit the data and adjust ARQ_TX_WINDOW according to the analysis result of the RX data analyzer 311. When the ACK for the transmitted data does not arrive for a period of time, the TX data adjuster 303 discards the corresponding data.

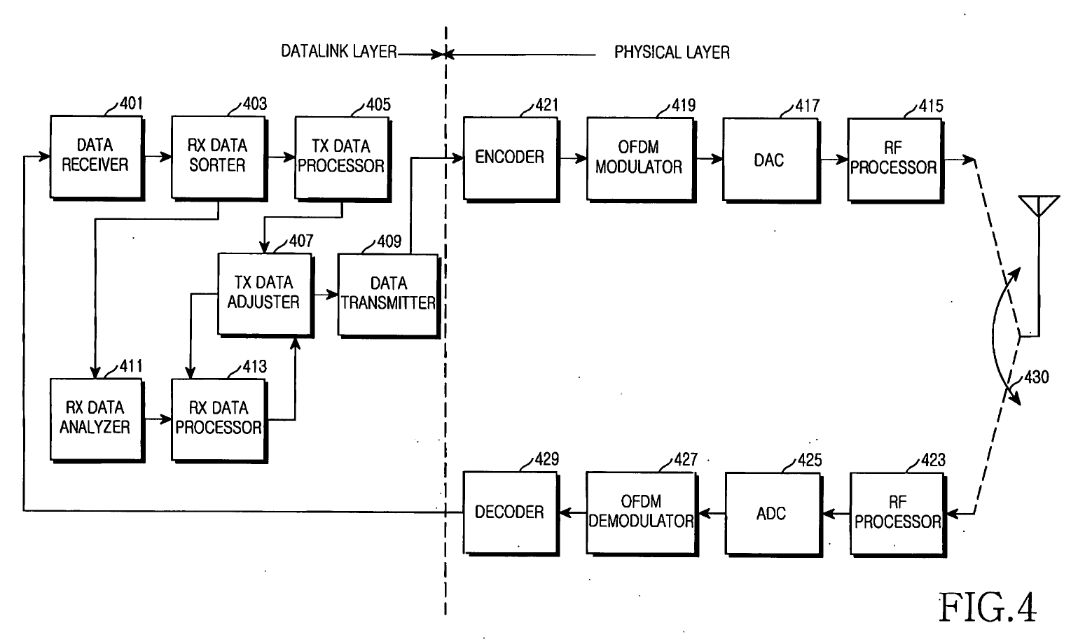

FIG. 4 is a block diagram of an ARQ apparatus of an MH-BTS according to the present invention.

Referring to FIG. 4, the ARQ apparatus of the MH-BTS is divided into a physical layer apparatus and a data link layer apparatus. The physical layer apparatus includes a transmitter, a receiver and an RF switch 430.

Although the physical layer apparatus using an OFDM scheme will be taken as an example, the present invention can also be applied to a CDMA scheme and a TDMA scheme using a TDD.

In addition, although the physical layer apparatus will be described focusing on a TDD system, the present invention can also be applied to an FDD system because the ARQ apparatus is independent of the physical layer apparatus. Elements and functions of the physical layer apparatus illustrated in FIG. 4 are similar to those of the physical layer apparatus illustrated in FIG. 3, but a significant difference is that a data transmitter 409 transmits data to an encoder 421 and a decoder 429 transmits data to a data receiver 401.

A data receiver 401 receives data from the decoder 429 and transmits the received data to an RX data sorter 403.

The RX data sorter 403 sorts the received data into data received from the source and data received from the destination. When the received data is the data transmitted from the source, it transmits the corresponding data to a TX data processor 405.

The TX data processor 405 processes the data received from the RX data sorter 403 and transmits the processed data to a TX data adjuster 407. The data processing is performed to generate feedback information indicating whether the MH-BTS successfully receives the data. The data transmitted from the transmitter to the receiver and the feedback information are transmitted to the TX data adjuster 407.

The TX data adjuster 407 manages a data transmission scheduling and a TX data processing, and transmits to the data transmitter 409 the feedback information to be transmitted to the source or the original data to be transmitted to the destination. The TX data adjuster 407 transmits the feedback data from the TX data processor 405 to the RX data processor. The TX data adjuster 407 transmits the feedback data provided from the RX data processor 413 to the data transmitter 409. The data transmitter 409 transmits the data to the encoder 421.

When the received data is ACK transmitted from the destination, the RX data sorter 403 transmits the data to the RX data analyzer 411.

The RX data analyzer 411 analyzes the received data to determine whether the destination receives the data, and transmits the determination result to the RX data processor 413.

The RX data processor 413 combines the feedback data (ACK) of the destination and the feedback data provided from the TX data adjuster 407, and generates feedback data to be transmitted to the source.

The generated feedback data is transmitted to the TX data adjuster 407, and the TX data adjuster 407 transmits the data to the data transmitter 409.

An operation of the MH-BTS 220 having the ARQ apparatus of FIG. 4 will be described below.

The MH-BTS 220 transmits the ARQ feedback message to the source using the dedicated ARQ feedback IE format. The dedicated ARQ feedback IE format is similar to the conventional ARQ feedback IE format, but it is different in the usage of the cumulative ACK MAP.

When the CID of the generic MAC header indicates the MH-BTS 220, the source recognizes that the ARQ feedback message is received from the MH-BTS 220, and analyzes the cumulative ACK MAP according to the dedicated ARQ feedback IE format.

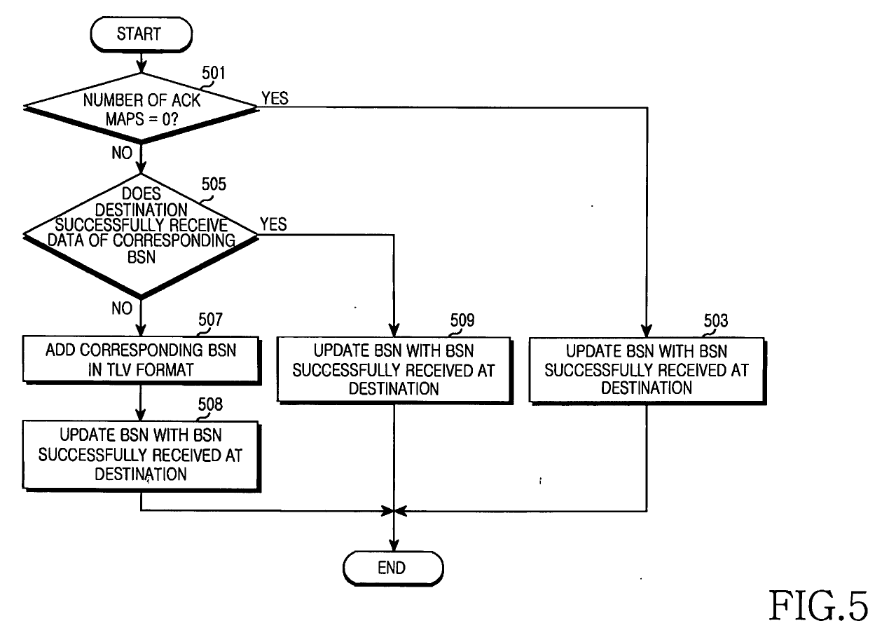

FIG. 5 is a flowchart illustrating the operation of the MH-BTS for generating the cumulative ACK MAP in the multihop according to the present invention.

Referring to FIG. 5, the MH-BTS 220 determines in step 501 whether number of ACK MAPs in the ARQ feedback IE of the received ARQ feedback message is zero. A “number of ACK MAPs” field will also be referred to herein as an “MH-type” field.

In step 503, when the number of ACK MAPs (MH-type) is zero, the BSN is updated with a BSN successfully received at the destination.

The BSN indicates a maximum value of ARQ block the destination successfully receives. In the case of the ACK ARQ, the existing MH-BTS field is reserved and set to 0.

Therefore, when the MH-type field is zero, the destination transmits the feedback data to the source without regard to the MH-BTS 220. Thus, the BSN outputted from the source corresponds to the BSN successfully received at the destination.

When the MH-type field is 0x1, it represents a 2-hop system. When the MH-type field is 0x2, it represents a 3-hop system. When the MH-type field is 0x3, it represents a 4-hop-or-more system. That is, information about how many hops the destination receives data through can be primarily obtained from the value of the MH-type field.

In step 505, when the MH-type field is not zero, it is determined whether the destination successfully receives the data from the MH-BTS 220.

When the destination is successful in step 505, the BSN is updated with a BSN successfully received at the destination in step 509.

When the destination fails in step 505, it indicates that the data is successfully transmitted up to the MH-BTS 220. Thus, the process proceeds to step 507 to add the corresponding BSN in a Type Length Value (TLV) format.

In step 508, the BSN is updated with the corresponding BSN successfully received at the destination.

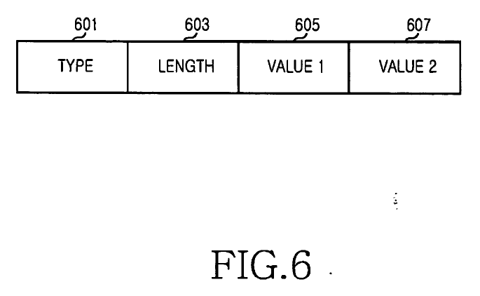

FIG. 6 illustrates the TVL format according to the present invention.

Referring to FIG. 6, a type 601 indicates the order of MH-BTSs. In this embodiment, the type 601 uses 2 bits. However, the bit length of the type 601 is variable.

A length 603 is a bit length of values 605 and 607 and has a size of (bit size of the type)×11 bits. The 11 bits are the number of bits required to indicate the BSN. In this embodiment, because the bit size of type 601 is 2 bits, the length 603 is 22 bits.

A value 1 605 is the smallest BSN of successive ARQ blocks that fail to be received by the destination, even though the MH-BTS 220 receives them from the source and then transmits to the destination. A value 2 607 is the largest BSN of the successive ARQ blocks that fail to be received at the destination, even though the MH-BTS 220 receives them from the source and then transmits to the destination.

Therefore, in the case of the ARQ feedback message transmitted through several MH-BTSs to the destination, the TLVs are stored successively.

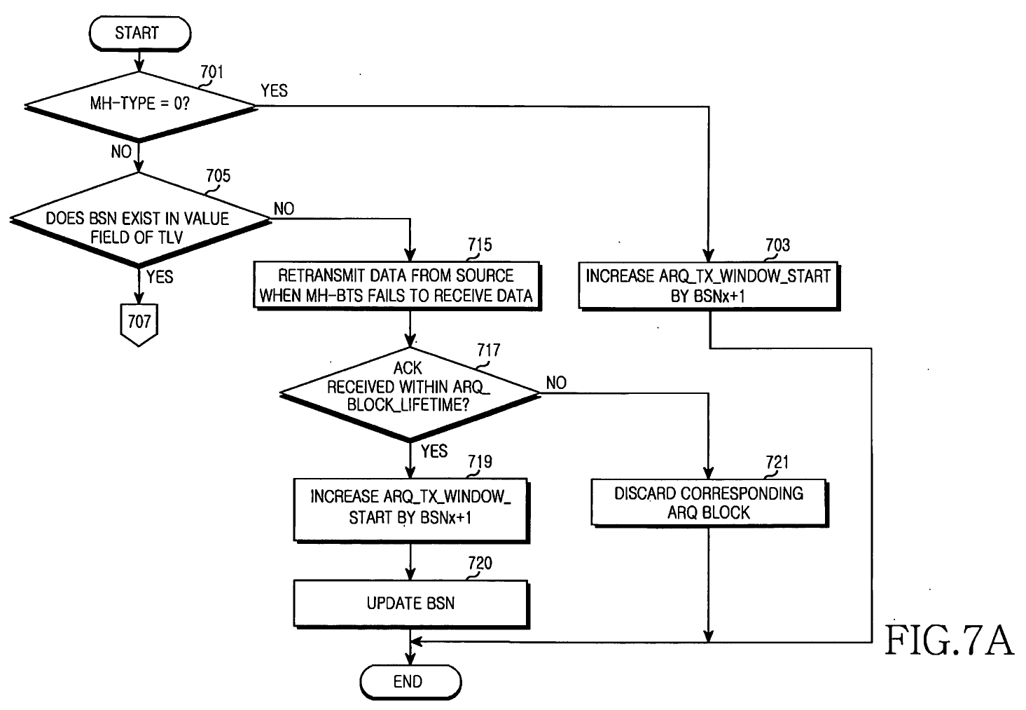

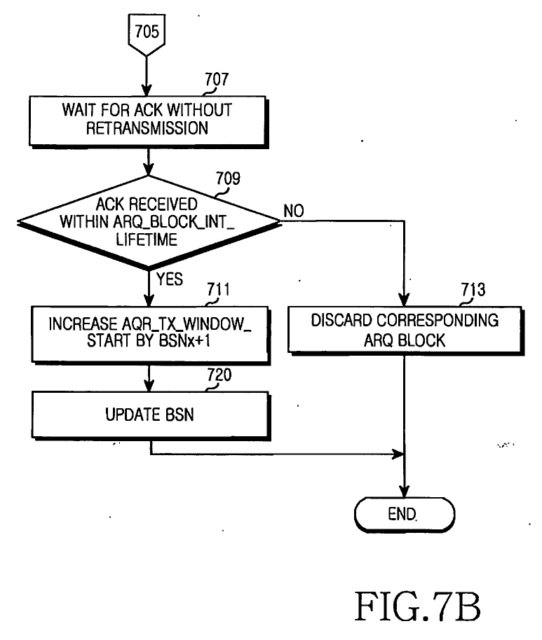

FIGS. 7A and 7B are flowcharts illustrating an analysis process of the source receiving the cumulative ACK MAP in the multihop according to the present invention.

Referring to FIGS. 7A and 7B, when the cumulative ACK ARQ feedback message is received, the source determines in step 701 whether the MH-type field is zero.

When the MH-type field is zero, it indicates that the data is directly transmitted to the destination without passing through the MH-BTS 220. Thus, the process proceeds to step 703 to increase ARQ_TX_WINDOW_START by BSNₓ+1. That is, the ARQ_TX_WINDOW_START is updated with a value greater by 1 than the BSN successfully received by the destination. The ARQ_TX_WINDOW_START is a window start BSN value when the ARQ block is transmitted.

When the MH-type field is not zero, the process proceeds to step 705 to determine whether the corresponding BSN exists in the value fields of the TLV within the cumulative ACK ARQ feedback message. When the MH-type field is 1, it represents a 2-hop system. When the MH-type field is 2, it represents a 3-hop system. When the MH-type field is 3, it represents a 4-or-more-hop system.

When the corresponding BSN exists in the value fields of the TLV in step 705, the process proceeds to step 707. In step 707, the source waits for ACK from the MH-BTS 200 without retransmission to the MH-BTS 220, because the MH-BTS 220 successfully receives the data although the destination fails to receive the data.

When the ACK is received while waiting for ARQ_BLOCK_INT_LIFETIME in step 709, the process proceeds to step 711. The ARQ_BLOCK_INT_LIFETIME is newly defined in the present invention and indicates a waiting time during which the ACK received from the destination when the MH-BTS 220 successfully retransmits the data can be transmitted to the source.

Step 711 represents that both the MH-BTS 200 and the destination successfully receive the data, and increases ARQ_TX_WINDOW_START by BSNₓ+1. In step 720, the destination updates the ARQ_TX_WINDOW_START with a value that is greater than the successfully received BSN by one.

In step 713, when the ACK is not received after waiting for ARQ_BLOCK_INT_LIFETIME, the process proceeds to step 713 to discard the corresponding ARQ block.

When the corresponding BSN does not exist in the value fields of the TLV, the process proceeds to step 715. In step 715, because the MH-BTS 220 also fails to receive the data, the source retransmits the data to the MH-BTS 220.

When the source receives the ACK within ARQ_BLOCK_LIFETIME, the process proceeds to step 719. The ARQ_BLOCK_LIFETIME indicates the lifetime of the ARQ block.

Step 719 represents that both the MH-BTS 220 and the destination successfully receive the data and increases the ARQ_TX_WINDOW_START by BSNₓ+1. That is, the destination updates the ARQ_TX_WINDOW_START with a value that is greater than the successfully received BSN by one.

In step 720, the corresponding BSN is updated with the successfully received BSN.

When the source does not receive the ACK within the ARQ_BLOCK_LIFETIME in step 717, the process proceeds to step 721 to discard the corresponding ARQ block. Then, the algorithm of the present invention is terminated.

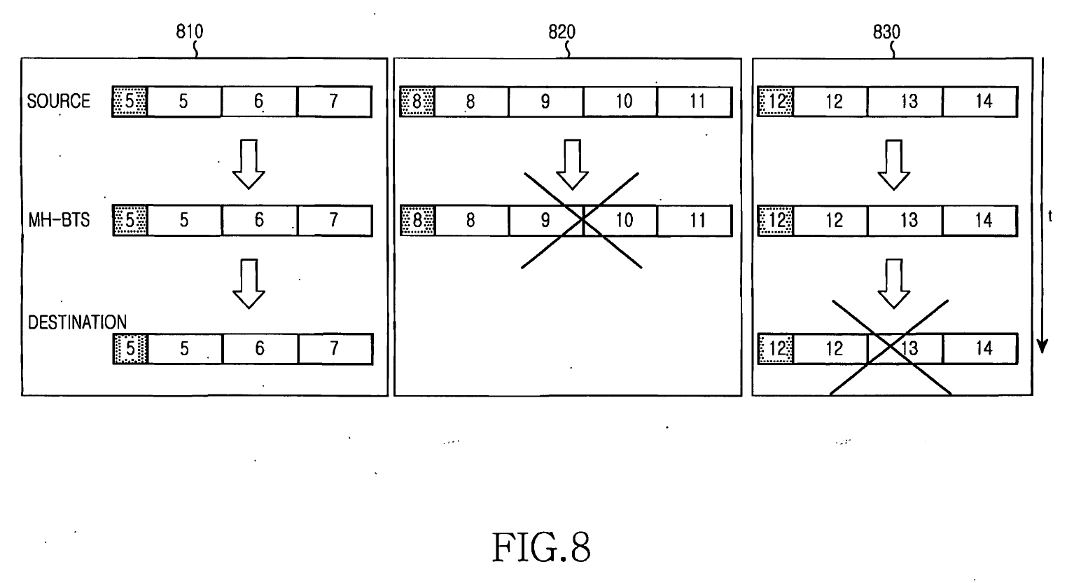

FIG. 8 illustrates an operation environment and a PDU TX/RX success/fail in a 2-hop system according to the present invention.

Referring to FIG. 8, when the SDU#1 105 and the SDU#2 110 are fragmented into three PDUs, fragmentation subheaders are inserted into the foremost of the PDUs 115, 120 and 125 in order to notify information about the PDUs 115, 120 and 125.

Referring to FIG. 8, the PDU#1 115 is successfully received at the MH-BTS 220 and the destination in step 810. In step 820, the PDU#2 fails to be received at the MH-BTS 220. In step 830, the PDU#3 125 is successfully received at the MH-BTS 220 but fails to be received at the destination.

Table 5 below shows ARQ feedback IE of ARQ block transmitted from the destination in the above-described environment.

TABLE 5

| Name | Size | Description |
|---|---|---|
| CID | ###### | Connection ID of destination |
| LAST | 1 | Indicates the last ARQ feedback IE |
| ACK Type | 0×1 | Indicates the use of cumulative ACK entry |
| BSN | 7 | Indicates that all blocks having a |
| | | smaller value than a corresponding |
| | | block are successfully received |
| Number of | 0×1 | The number of MH-BTS is 1. |
| ACK MAPs | | |

Table 6 below shows ARQ feedback IE of ARQ block in the MH-BTS 220 receiving the ARQ feedback IE of the ARQ block transmitted from the destination.

TABLE 6

| Name | Size | Description |
|---|---|---|
| CID | ###### | Connection ID of destination |
| LAST | 1 | Indicates last ARQ feedback IE |
| ACK Type | 0×1 | Indicates the use of cumulative ACK entry |
| BSN | 7 | Indicates that all blocks having a |
| | | smaller value than a |
| | | corresponding block successfully |
| | | receive data |
| Number of | 0×0 | 00 = Reserved |
| ACK MAPs | | |
| TLV | 01 010110 | ARQ block TX/RX states of MH-BTS |
| | 00000001100 | |
| | 00000001110 | |

In the TLV of Table 6, the type 601 is variable. In this embodiment, the type 601 is 2 bits and its the value is 1, which indicates the first MH-BTS.

The length 603 is 6 bits and indicates a size of (type size×11 bits). In Table 6, the length 603 has 22 bits.

The value 1 605 is 11 bits and indicates the smallest BSN among BSNs that are successfully received at the MH-BTS but fail to be received at the MS as illustrated in FIG. 6. In Table 6, the value 1 605 is 12.

The value 2 607 is 11 bits and indicates the largest BSN among BSNs that are successfully received at the MH-BTS but fail to be received. In Table 6, the value 2 607 is 14.

The CID of the generic MAC header in the ARQ feedback message containing the ARQ feedback IE is transmitted using the CID of the MH-BTS 220. Therefore, the source can recognize that ARQ feedback message is received from the MH-BTS 220 by using the generic MAC header, and can determine which destination the message is associated with by using the CID of the ARQ feedback IE.

When the source recognizes that the ARQ feedback message is received from the MH-BTS 220 by using the CID of the generic MAC header, it analyzes the cumulative ACK MAP. Since the received BSN is 7, it can be recognized that the blocks having the BSN of 1-7 are successfully transmitted to the destination.

Therefore, ARQ_TX_WINDOW is adjusted. That is, the ARQ_TX_WINDOW_START increases to 8 because the transmission succeeds up to the block having the BSN of 7.

The ARQ_TX_WINDOW_START indicates that the source successfully transmits the ARQ blocks having the BSN smaller than the ARQ_TX_WINDOW_START.

When the number of ACK MAPs received by the source is not zero (e.g., 0x1), the source recognizes the use of the MH-BTS 220 and reads the TLV.

Although the BSN is 7, the values of 12 and 14 are obtained from the TLV. Thus, the source recognizes that the MH-BTS 220 fails to receive the blocks having the BSN of 8-11. Consequently, the source retransmits the corresponding ARQ block to the MH-BTS 220.

When the ACK is not received even after waiting for ARQ_BLOCK_LIFETIME, the corresponding ARQ block is discarded. When the ACK for the blocks having the BSN of 8-11 is received before discarding the corresponding ARQ block, the ARQ_TX_WINDOW_START increases to 12 and the corresponding BSN is modified to 11.

In addition, because the source obtains the BSNs of 12 and 14 from the TLV, the source recognizes that the MH-BTS 220 successfully receives the blocks having the BSN of 12-14, but the destination fails to receive them.

Therefore, the source does not perform the retransmission with respect to the BSNs of 12-14, but waits for the ACK. When the ACK is not received even after the ARQ_BLOCK_INT_LIFETIME, the source discards the corresponding ARQ block.

When the ACK for the blocks having the BSNs of 12-14 is received before the ARQ_BLOCK_INT_LIFETIME passes by, the ARQ_TX_WINDOW_START increases to 15 and the corresponding BSN is modified to 14.

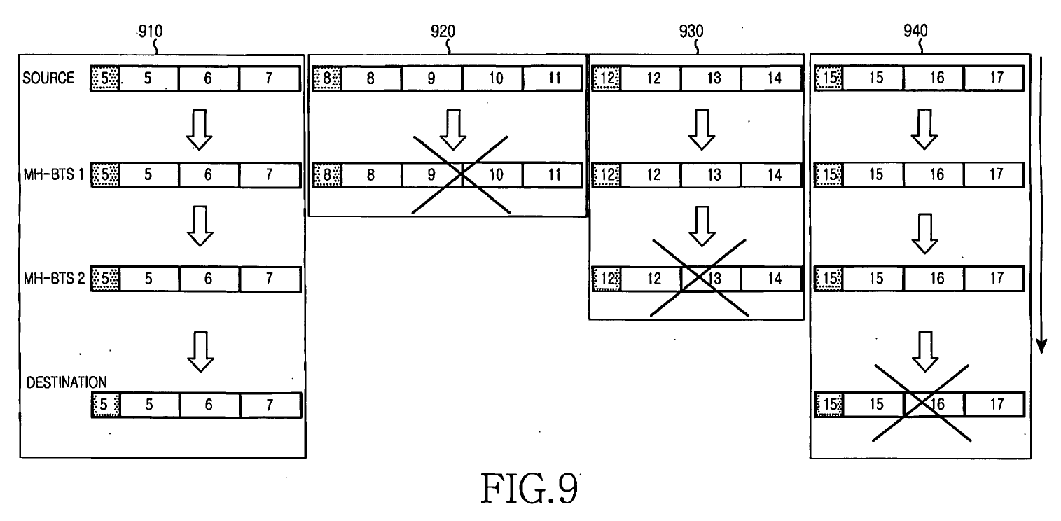

FIG. 9 illustrates an operation environment and a PDU TX/RX success/fail in a 3-hop system according to the present invention.

Referring to FIG. 9, a PDU#1 910 is successfully received at both the MH-BTSs and the destination, and a PDU#2 920 fails to be received at the first MH-BTS. A PDU#3 930 is successfully received at the first MH-BTS but fails to be received at the second MH-BTS. A PDU#4 940 is successfully received at the first MH-BTS and the second MH-BTS but fails to be received at the destination.

Table 7 below shows ARQ feedback IE of ARQ block in the first MH-BTS receiving the ARQ feedback IE of the ARQ block of the second MH-BTS in the above-described environment.

TABLE 7

| Name | Size | Description |
|---|---|---|
| CID | ###### | Connection ID of destination |
| LAST | 1 | Indicates last ARQ feedback IE |
| ACK Type | 0×1 | Indicates the use of cumulative ACK entry |
| BSN | 7 | Indicates that all blocks having |
| | | a smaller value than a |
| | | corresponding block are successfully |
| | | received |
| Number of | 0×2 | The number of MH-BTS is 2 |
| ACK MAPs | | |
| TLV1 | 01 010110 | ARQ block TX/RX states of the first |
| | 00000001100 | MH-BTS |
| | 00000001110 | |
| TLV2 | 10 010110 | ARQ block TX/RX states of the |
| | 00000001111 | second MH-BTS |
| | 00000010001 | |

In the 3-hop environment, the TLV of Table 7 includes two TLVs, i.e., TLV1 and TLV2. The TLV1 indicates the TX/RX states of the ARQ blocks from the destination to the first MH-BTS, and the TLV2 indicates the TX/RX states of the ARQ blocks from the first MH-BTS to the second MH-BTS.

As illustrated in FIG. 6, the type 601 of the TLV1 is variable, but 2 bits are used in this embodiment. In Table 8, the type 601 is 1, which indicates the first MH-BTS.

The length 603 is 6 bits and a size of (type size×11 bits). In Table 7, the length 603 has 22 bits.

The value 1 605 is 11 bits and indicates the smallest BSN among BSNs that are successfully received at the first MH-BTS but fail to be received at the second MH-BTS. In Table 7, the value 1 605 is 12.

The value 2 607 is 11 bits and indicates the largest BSN among BSNs that are successfully received at the first MH-BTS but fail to be received at the second MH-BTS. In Table 7, the value 2 607 is 14.

In this embodiment, the type 601 of the TLV2 is 2 bits. In Table 8, the type 601 is 2, which indicates the second MH-BTS.

The length 603 is 6 bits. In Table 7, the length 603 is 22. The value 1 605 is 11 bits and indicates the smallest BSN among BSNs that are successfully received at the first MH-BTS and the second MH-BTS but fail to be received at the MS. In Table 7, the value 1 605 is 15. The value 2 607 is 11 bits and indicates the largest BSN among BSNs that are successfully received at the first MH-BTS and the second MH-BTS but fail to be received at the MS. In Table 7, the value 2 607 is 17.

The CID of the generic MAC header of the ARQ feedback message containing the ARQ feedback IE is transmitted using the CID of the MH-BTS 220. Therefore, the source can recognize that ARQ feedback message is received from the MH-BTS 220 by using the generic MAC header, and can determine which destination the message is associated with by using the CID of the ARQ feedback IE.

When the source recognizes that the ARQ feedback message is received from the first MH-BTS 220 by using the CID of the generic MAC header, it analyzes the cumulative ACK MAP. Since the received BSN is 7, it can be recognized that the blocks having BSN of 1-7 are successfully transmitted to the destination.

Therefore, ARQ_TX_WINDOW is adjusted. That is, the ARQ_TX_WINDOW_START increases to 8 because the transmission succeeds up to the block having the BSN of 7.

The ARQ_TX_WINDOW_START indicates that the source successfully transmits ARQ blocks having the BSN smaller than the ARQ_TX_WINDOW_START.

When the number of ACK MAPs received by the source is not zero (e.g., 0x2), the source recognizes that two MH-BTSs are used, and reads the TLV.

Although the BSN is 7, the values of 12 and 14 and the values of 15 and 17 are obtained from the TLV1 and the TLV2, respectively. Thus, the source recognizes that the first MH-BTS fails to receive the blocks having the BSN of 8-11. Consequently, the source retransmits the corresponding ARQ blocks to the first MH-BTS.

When the ACK is not received even after waiting for ARQ_BLOCK_LIFETIME, the source discards the corresponding ARQ block. When the ACK for the blocks having the BSN of 8-11 is received before discarding the corresponding ARQ block, the ARQ_TX_WINDOW_START increases to 12 and the corresponding BSN is modified to 11.

Because the BSNs of 12 and 14 are obtained from the TLV1, the source recognizes that the first MH-BTS successfully receives the blocks having the BSNs of 12-14 but the second MH-BTS fails to receive them.

Therefore, the source does not retransmit the ARQ blocks having the BSNs of 12-14, but waits for ACK. When the ACK is not received even after the ARQ_BLOCK_INT_LIFETIME, the source discards the corresponding ARQ block.

When the ACK for the blocks having the BSNs of 12-14 is received before the ARQ_BLOCK_INT_LIFETIME passes by, the ARQ_TX_WINDOW_START increases to 15 and the corresponding BSN is modified to 14.

Because the BSNs of 15-17 are obtained from the TLV2, the source recognizes that the second MH-BTS successfully receives the blocks having the BSNs of 15-17 but the destination fails to receive them.

Therefore, the source does not retransmit the ARQ blocks having the BSNs of 15-17, but waits for ACK. When the ACK is not received even after the ARQ_BLOCK_INT_LIFETIME, the source discards the corresponding ARQ block.

When the ACK for the blocks having the BSNs of 15-17 is received before the ARQ_BLOCK_INT_LIFETIME passes by, the ARQ_TX_WINDOW_START increases to 18 and the corresponding BSN is modified to 17.

In the case of the forward link, the MS 230 and the BTS 210 are the destination and the source, respectively. When there are a plurality of MH-BTSs, the MH-BTS first connected to the BTS 210 is the first MH-BTS, and the MH-BTS first connected to the MS 230 is the last MH-BTS. The MH-BTS closer to the BTS 210 is the upper MH-BTS.

In the case of the reverse link, the MS 230 and the BTS 210 are the source and the destination, respectively. The MH-BTS first connected to the MS 230 is the first MH-BTS, and the MH-BTS first connected to the BTS 210 is the last MH-BTS. The MH-BTS closer to the MS 230 is the upper MH-BTS.

As described above, when the ARQ technology is applied to the multihop system in the broadband wireless access communication network, the MS can transparently manage the ARQ state between the MS and the BTS without regard to the MH-BTS. Thus, the complexity of the MH-BTS can be reduced.

In addition, when the MH-BTS successfully receives data from the BTS while the MS fails to receive the data, it is possible to prevent the BTS from retransmitting the same data to the MH-BTS.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An Automatic ReQuest (ARQ) apparatus of a transmitter in a wireless access communication network, comprising:
a receive data sorter for sorting received data according to transmission nodes;
a receive data analyzer for analyzing the sorted data, deciding not to retransmit data that is successfully received at a relay but fails to be received at a destination, and deciding to retransmit data that fails to be received at the relay; and
a transmit data adjuster for transmitting the data according to the decision of the receive data analyzer.

2. The automatic request apparatus of claim 1, wherein the receive data analyzer determines the data that is successfully received at the relay or the destination and the data that fails to be received at the relay or the destination, by using ARQ feedback information element, the ARQ feedback information element including number of relays, information indicating an n^{th} relay, bit size of Block Sequence Number (BSN), a smallest BSN of successive ARQ blocks that are successfully received at the n^{th} relay but fail to be received at a lower node of the n^{th} relay, and a largest BSN of the successive ARQ blocks that are successfully received at the n^{th} relay but fail to be received at the lower node of the n^{th} relay.

3. The automatic request apparatus of claim 1, wherein the transmit data adjuster decides not to retransmit the data that is successfully received at the relay but fails to be received at the destination, and waits for ACKnowledgement (ACK) for a period of time.

4. An automatic request apparatus of a relay in a wireless access communication network, comprising:
a receive data sorter for sorting received data according to transmission nodes;
a receive data analyzer for analyzing the data of a lower node, which is received from the receive data sorter, and determining whether the lower node successfully receives the data;
a transmit data processor for generating a first feedback data including the information about data reception success/fail of an upper node and outputting the first feedback data together with the data of the upper node;
a receive data processor for receiving a result of the analysis of the receive data analyzer and the first feedback data to generate a second feedback data to be transmitted to the upper node, the second feedback data including reception success/fail of the lower node including the relay; and
a transmit data adjuster for receiving the first feedback data from the transmit data processor to output the received first feedback data to the receive data processor, scheduling the data of the upper node and the second feedback data, and transmitting the data and the second feedback data through an antenna.

5. The automatic request apparatus of claim 4, wherein the receive data analyzer determines the data that is successfully received at the lower node and the data that fails to be received at the lower node, by using ARQ feedback information element of the received data, the ARQ feedback information element including a number of relays, information indicating an n^{th} relay, bit size of Block Sequence Number (BSN), a smallest BSN of successive ARQ blocks that are successfully received at the n^{th} relay but fail to be received at a lower node of the n^{th} relay, and a largest BSN of the successive ARQ blocks that are successfully received at the n^{th} relay but fail to be received at the lower node of the n^{th} relay.

6. The automatic request apparatus of claim 5, wherein the value of n is an integer greater than zero.

7. The automatic request apparatus of claim 4, wherein the second feedback data is ARQ feedback information element including number of relays, information indicating the relay, bit size of Block Sequence Number (BSN), a smallest BSN of successive-ARQ blocks that are successfully received at the relay but fail to be received at a lower node of the relay, and a largest BSN of the successive ARQ blocks that are successfully received at the relay but fail to be received at the lower node of the relay.

8. The automatic request apparatus of claim 4, wherein the relay retransmits the data that fails to be received at the lower node, when the relay successfully receives the data.

9. An automatic request method of a transmitter in a broadband wireless access communication network, comprising:
transmitting data to a relay;
receiving feedback data for the transmitted data from the relay;
analyzing the received feedback data to determine whether a destination or the relay successfully receives the data;
retransmitting the data to the relay when the relay fails to receive the data; and
holding off retransmitting the data when the relay successfully receives the data and the destination fails to receive the data.

10. The automatic request method of claim 9, wherein the feedback data from the relay includes information element including number of relays, information indicating an n^{th} relay, and bit size of Block Sequence Number (BSN).

11. The automatic request method of claim 9, wherein the feedback data from the relay includes information element including a smallest Block Sequence Number (BSN) of successive ARQ blocks that are successfully received at an n^{th} relay but fail to be received at a lower node of the n^{th} relay, and a largest BSN of the successive ARQ blocks that are successfully received at the n^{th} relay but fail to be received at the lower node of the n^{th} relay.

12. The automatic request method of claim 9, wherein the step of holding off retransmitting the data further comprises waiting for ACKnowledgement (ACK) for a period of time.

13. An automatic request method of a relay in a wireless access communication network, comprising:
determining if data from an upper node is successfully received;
transmitting the data to a lower node after the determining step;
receiving first feedback data for the data from a lower node;
generating second feedback data which includes the first feedback data and information on the determination of success/failure for the data reception from the upper node; and
transmitting the second feedback data to the upper node.

14. The automatic request method of claim 13, further comprising retransmitting the data when it is determined from the first feedback data that the lower node fails to receive the data and from the determination of success for the data reception from the upper node.

15. The automatic request method of claim 13, wherein the first feedback data includes information element including number of relays, information indicating an n^{th} relay, bit size of Block Sequence Number (BSN).

16. The automatic request method of claim 13, wherein the first feedback data includes information element including a smallest Block Sequence Number (BSN) of successive ARQ blocks that are successfully received at an n h relay, wherein the value of n is an integer greater than zero, but fail to be received at a lower node of the n^{th} relay, and a largest BSN of the successive ARQ blocks that are successfully received at the n^{th} relay but fail to be received at the lower node of the n^{th} relay.

17. The automatic request method of claim 13, wherein the second feedback data is ARQ feedback information element including number of relays, information indicating a relay, bit size of Block Sequence Number (BSN), a smallest BSN of successive ARQ blocks that are successfully received at the relay but fail to be received at a lower node of the relay, and a largest BSN of the successive ARQ blocks that are successfully received at the relay but fail to be received at the lower node of the relay.

18. An automatic request system in a wireless access communication network, comprising:
a source node for analyzing received data and retransmitting data that fails to be received at a relay, while not retransmitting data that is successfully received at the relay but fails to be received at a destination node;
a relay for determining whether the data from the source node is successfully received, receiving first feedback data from a lower node during or after the determining step, generating second feedback data when it is determined from the first feedback data that the lower node fails to receive the data and the relay successfully receives the data, and transmitting the first feedback data and the second feedback data to the source node, the second feedback data including the determination result indicating whether the data from the source node is successfully received.

19. The automatic request system of claim 18, wherein the relay retransmits the data when it is determined from the first feedback data that the lower node fails to receive the specific data and the relay successfully receives the data.

20. The automatic request system of claim 18, wherein the relay determines the data that is successfully received at the relay or the destination and the data that fails to be received at the relay or the destination, by using ARQ feedback information element of the first feedback data, the ARQ feedback information element including number of relays, information indicating an n^{th} relay, bit size of Block Sequence Number (BSN), a smallest BSN of successive ARQ blocks that are successfully received at the n^{th} relay but fail to be received at a lower node of the n^{th} relay, and a largest BSN of the successive ARQ blocks that are successfully received at the n^{th} relay but fail to be received at the lower node of the n^{th} relay.

21. The automatic request system of claim 20, wherein the value of n is an integer greater than zero.

22. The automatic request system of claim 18, wherein the second feedback data is ARQ feedback information element including number of relays, information indicating a relay, bit size of Block Sequence Number (BSN), a smallest BSN of successive ARQ blocks that are successfully received at the relay but fail to be received at a lower node of the relay, and a largest BSN of the successive ARQ blocks that are successfully received at the relay but fail to be received at the lower node of the relay.

23. The automatic request system of claim 18, wherein the source node determines the data that is successfully received at the relay or the destination and the data that fails to be received at the relay or the destination, by using ARQ feedback information element, the ARQ feedback information element including number of relays, information indicating an n^{th} relay, bit size of Block Sequence Number (BSN), a smallest BSN of successive ARQ blocks that are successfully received at the n^{th} relay but fail to be received at a lower node of the n^{th} relay, and a largest BSN of the successive ARQ blocks that are successfully received at the n^{th} relay but fail to be received at the lower node of the n^{th} relay.

24. The automatic request system of claim 18, wherein the source node decides not to retransmit the data that is successfully received at the relay but fails to be received at the destination, and waits for ACKnowledgement (ACK) for a period of time.

25. A wireless access communication network comprising a Automatic ReQuest (ARQ) apparatus of a transmitter, comprising:
a deciding means for deciding not to retransmit data that is successfully received at a relay but fails to be received at a destination, and deciding to retransmit data that fails to be received at the relay; and
a transmitting means for transmitting the data according to the decision of the deciding means.
